(19) United States
(12) Patent Application Publication
(10) Pub. No.: US 2008/0224993 A1
(43) Pub. Date: Sep. 18, 2008

(54) In-Plane Switching Display Devices

(75) Inventor: Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,771

(22) PCT Filed: Oct. 10, 2006
(86) PCT No.: PCT/IB2006/053708

§ 371 Date: Apr. 10, 2008

(30) Foreign Application Priority Data
Oct. 14, 2005 (EP) 05109557.8

(51) Int. Cl. G02F 1/167; G09G 3/20

(52) U.S. Cl. 345/107; 345/55

(57) ABSTRACT

A display device comprises an array of rows and columns of pixels, wherein each pixel (48) comprises portions of first and second row-wise electrodes (42) and portions of first and second column-wise electrodes (34). This pixel arrangement has a unique combination of four electrodes dedicated to each pixel, and arranged as two pairs of parallel electrodes. The parallel pairs of electrodes can easily be manufactured, and each pair can be on a different substrate, or both pairs can be on the same substrate. This structure is used in electrophoretic displays.

This invention relates to display devices, in particular in plane switching electrophoretic display devices.

Electrophoretic display devices are one example of bistable display technology, which use the movement of particles within an electric field to provide a selective light scattering or absorption function.

In one example, white particles are suspended in an absorptive liquid, and the electric field can be used to bring the particles to the surface of the device. In this position, they may perform a light scattering function, so that the display appears white. Movement away from the top surface enables the colour of the liquid to be seen, for example black. In another example, there may be two types of particle, for example black negatively charged particles and white positively charged particles, suspended in a transparent fluid. There are a number of different possible configurations.

It has been recognised that electrophoretic display devices enable low power consumption as a result of their bistability (an image is retained with no voltage applied), and they can enable thin display devices to be formed as there is no need for a backlight or polariser. They may also be made from plastics materials, and there is also the possibility of low cost roll-to-roll processing in the manufacture of such displays.

For example, the incorporation of an electrophoretic display device into a smart card has been proposed, taking advantage of the thin and intrinsically flexible nature of a plastic substrate, as well the low power consumption.

If costs are to be kept as low as possible, passive addressing schemes are employed. The most simple configuration of display device is a segmented reflective display, and there are a number of applications where this type of display is sufficient. A segmented reflective electrophoretic display has low power consumption, good brightness and is also bistable in operation, and therefore able to display information even when the display is turned off.

However, improved performance and versatility is provided using a matrix addressing scheme. An electrophoretic display uses passive matrix addressing typically comprises a lower electrode layer, a display medium layer, and an upper electrode layer. Biasing voltages are applied selectively to electrodes in the upper and/or lower electrode layers to control the state of the portion(s) of the display medium associated with the electrodes being biased.

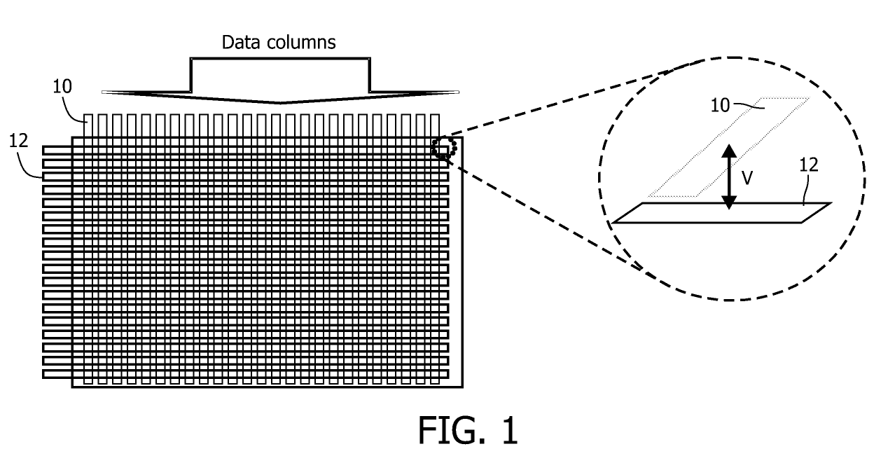

FIG. 1 shows a known passive matrix display layout for generating perpendicular electric fields between the top column electrodes 10 and the bottom row electrodes 12. The electrodes are generally situated on two separate substrates.

The passive matrix electrophoretic display comprises an array of electrophoretic cells arranged in rows and columns and sandwiched between the top and bottom electrode layers. The column electrodes 10 are transparent.

Cross bias is a problem in the design of passive matrix displays. Cross bias refers to the bias voltages applied to electrodes that are associated with display cells that are not in the scanning row (the row being updated with display data). For example, to change the state of cells in a scanning row in a typical display, bias voltages might be applied to column electrodes in the top electrode layer for those cells to be changed, or to hold cells in their initial state. Such column electrodes are associated with all of the display cells in their column, including the many cells not located in the scanning row.

Another type of electrophoretic display device uses so-called “in plane switching”. This type of device uses movement of the particles selectively laterally in the display material layer. When the particles are moved towards lateral electrodes, an opening appears between the particles, through which an underlying surface can be seen. When the particles are randomly dispersed, they block the passage of light to the underlying surface and the particle colour is seen. The particles may be coloured and the underlying surface black or white, or else the particles can be black or white, and the underlying surface coloured.

An advantage of in-plane switching is that the device can be adapted for transmissive operation, or transflective operation. In particular, the movement of the particles creates a passageway for light, so that both reflective and transmissive operation can be implemented through the material.

The in-plane electrodes may all be provided on one substrate, or else both substrates may be provided with electrodes. The need to avoid unnecessary cross-overs within the structure is a design limitation which has influenced the pixel design within this type of display device.

In the simplest implementation, each pixel is associated with two electrodes, but there are also designs using three electrodes per pixel; a pixel electrode, a reservoir electrode and a gate electrode.

This invention relates specifically to in-plane switching display devices, and aims to provide improved pixel designs.

According to the invention, there is provided a display device comprising an array of rows and columns of pixels, wherein each pixel comprises portions of first and second row-wise electrodes and portions of first and second column-wise electrodes.

This pixel arrangement has a unique combination of four electrodes dedicated to each pixel, and arranged as two pairs of parallel electrodes. The parallel pairs of electrodes can easily be manufactured, and each pair can be on a different substrate, or both pairs can be on the same substrate. The pixels are preferably provided over a common substrate.

Each pixel can be bounded by the first and second row-wise electrodes, which are not shared with any other rows, and the first and second column-wise electrodes, which are not shared with any other columns.

Alternatively, one of more of the row-wise or column-wise electrodes may be shared by more than one pixel, providing that at least one of the row-wise electrodes are not shared with any other rows, and at least one of the column-wise electrodes are not shared with any other columns.

If the first and second row-wise electrodes and the first and second column-wise electrodes are provided on a common substrate, the first and second row-wise electrodes can be provided as a first patterned metal layer and first and second column-wise electrodes can be provided as a second patterned metal layer, with an insulating layer between the metal layers.

In one example, the column-wise electrodes comprise a shielding electrode and a data electrode, and the row-wise electrodes comprise a reservoir electrode and a select electrode. This arrangement provides an additional shielding electrode within the pixel structure, and this can be used to reduce cross talk.

In another example, the column-wise electrodes comprise first and second data electrodes and the row-wise electrodes comprise a reservoir electrode and a select electrode. This arrangement provides an additional data electrode within the pixel structure, and this can be used to improve pixel switching characteristics.

In each case, the data electrode (or one of them) connects to pixel electrode pads. The invention is of particular benefit for electrophoretic passive matrix display devices.

Examples of the invention will now be described in detail with reference to the accompanying drawings, in which:

FIG. 1 shows a known passive matrix display layout;

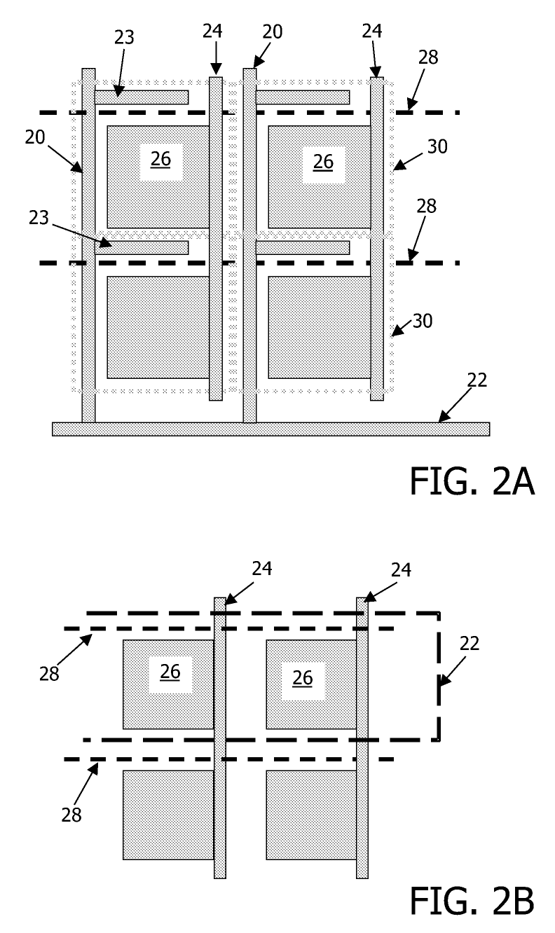

FIGS. 2A and 2B show examples of possible in-plane switching pixel layouts;

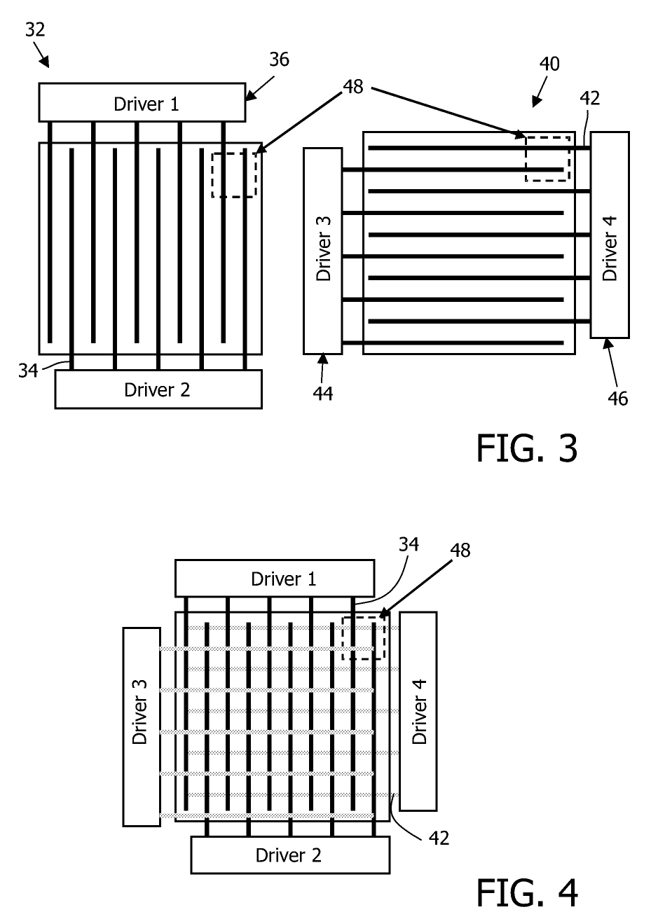

FIG. 3 shows in schematic form a first example of pixel structure for a device of the invention;

FIG. 4 shows in schematic form a display device of the invention using a second example of pixel structure;

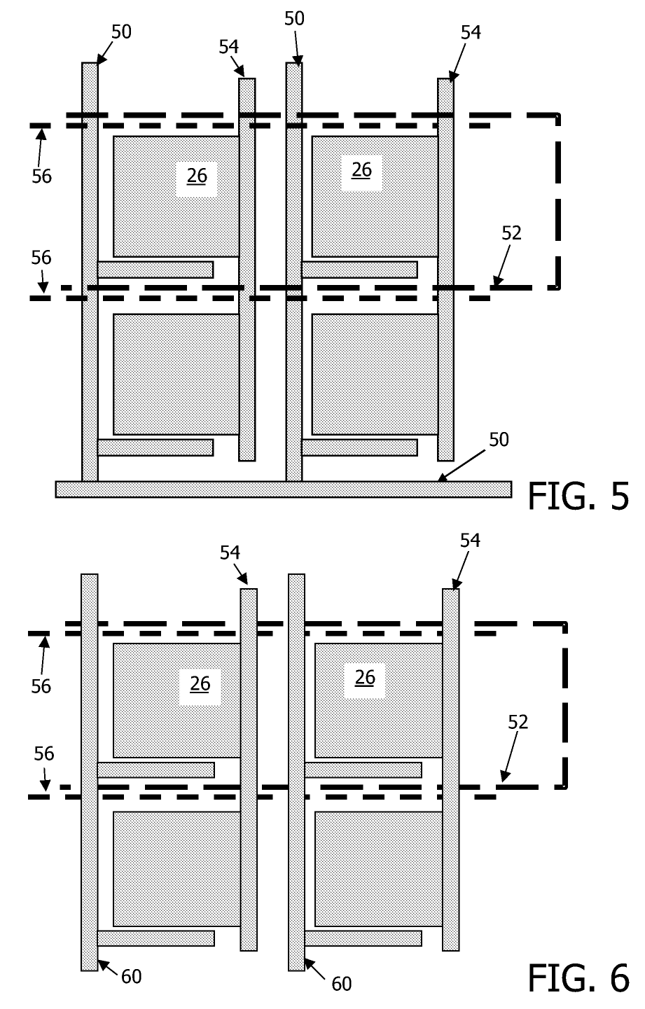

FIG. 5 shows a in more detail a first example of pixel layout of the invention; and

FIG. 6 shows a in more detail a second example of pixel layout of the invention.

The same references are used in different Figures to denote the same layers or components, and description is not repeated.

FIG. 2 shows two examples of pixel layouts which have been proposed by the applicant.

In FIG. 2A, first column electrodes 20 connect to a common reservoir electrode 22. The column electrodes 20 include spurs 23. Second column electrodes (data electrodes) 24 connect to pixel electrodes 26, and gate/select electrodes 28 run in the row direction.

Each pixel thus comprises three electrodes. The pixel electrode is used to move the particles into the visible portion of the pixel, and for this reason the pixel electrode 26 occupies most of the pixel area. Each pixel area is shown in FIG. 2A as area 30. The reservoir electrode 20,22,23 is used to move the particles laterally to the hidden portion of the pixel. The gate electrode 28 is used to prevent movement of the particles from the reservoir portion into the visible portion of the pixel in all lines other than the selected line, and thus enables row by row operation of the pixels. Essentially, the gate electrode 28 operates to interrupt the electric field between the data electrode and the pixel electrode, so that a driving voltage on the pixel electrode only causes movement of particles for a selected row, for which the electric filed is not interrupted.

This gate electrode 28 is required as a result of the passive addressing scheme, and is needed to provide different conditions to a selected row than to non-selected rows.

In FIG. 2B, the common reservoir electrode 22 is arranged as multiple row electrodes instead of as spurs from column electrodes, but the operation of the pixel is the same.

The pixel layouts of FIG. 2 can be created without requiring any cross-over structures on either of the two substrates. This enhances the manufacturability of the structure, particularly if the device is to be made in a roll-to-roll manufacturing method.

The first substrate comprises the reservoir, data and pixel electrodes 20,23,24,26, and an opposing substrate is provided with the gate electrodes 28. The pixel electrodes 26 are all individually driven by data drivers. Optionally, pixel walls may be built up to surround every pixel to isolate pixels from each other, and the space between the substrates is filled with electrophoretic fluid.

This invention relates to this type of passive matrix array arrangement using in in-plane switching. The invention provides a pixel design with four dedicated electrodes per pixel, two row electrodes and two column electrodes. The operation of each pixel with a unique combination of four control electrodes enables various different drive schemes to be implemented. However, it is possible to introduce the forth pixel electrode to the passive matrix display pixel without increasing the complexity of fabrication as compared to the 2 or 3 electrode case. This enables low cost fabrication methods, such as roll-to-roll fabrication, to be kept.

FIG. 3 shows a first arrangement of four electrode in-plane switching passive matrix pixel of the invention, and which avoids the requirement of any crossover structures.

This embodiment provides in-plane electrodes on each substrate. The bottom substrate is shown to the left of the figure and the top substrate is shown to the right of the figure.

The bottom substrate 32 has an array of column electrodes 34, with alternate column electrodes connecting to different driver circuits, one 36 at the top and one 38 at the bottom of the display. An adjacent pair of the column electrodes are for each column of pixels.

The top substrate 40 has an array of row electrodes 42, with alternate row electrodes connecting to different driver circuits, one 44 at the left and one 46 at the right of the display. An adjacent pair of the row electrodes are for each row of pixels.

On one or both of the substrates, one of the two drivers could drive more than one column electrode or row electrode associated with the driver simultaneously, and optionally may drive all of the column electrodes or row electrodes associated with the driver simultaneously. An equivalent situation may be realized by electrically connecting more than one column electrode or row electrode before attaching the electrode to the associated driver. Optionally, all of the column electrodes or row electrodes may be electrically connected before attaching the electrode to the associated driver. In all cases, a reduced driver electronics cost is realized.

The pixel area is shown as 48 and the pixel area is bounded by four electrode lines, two from each substrate.

This layout provides a four electrode in-plane switching passive matrix pixel, without the requirement of any crossover structures. Two electrode arrays are provided on each of the substrates, with feed-out of the electrodes to opposite sides of the substrates. In this manner, the two electrode arrays on each substrate can be patterned without requiring a crossover.

The display is completed by coupling the two substrates such that feed-outs to all four sides of the display are present. In this arrangement, pixels can be created with four electrodes per pixel without requiring any cross-over structures on either substrate. This simplifies the manufacture of the structure, particularly if the device is to be made in a roll-to-roll manufacturing method. However, correct relative alignment of the two substrates is required. If more than one of the column or row electrodes are electrically connected together, the electrical connections must be situated outside of the display area and at the side of the display opposite to that used to drive the at least one of the row-wise electrodes which are not shared with any other rows, and/or at least one of the column-wise electrodes which are not shared with any other columns. However, in this arrangement, the common electrode feed-out may be routed, outside of the display area, to any side of the display, including that where the driver electrode is situated. Again, in this arrangement, pixels can be created with four electrodes per pixel without requiring any cross-over structures on either substrate.

In the example of FIG. 4, the four electrode in-plane switching passive matrix pixel configuration is provided with a single crossover layer, in order to isolate the two electrode arrays 34 in the lower layer from the two electrode arrays 42 in the upper metal layer. FIG. 4 shows an example of a complete display device of the invention in schematic form.

This arrangement uses two layers, each layer having two arrays of electrodes as shown on the separate substrates in FIG. 3. The two layers are separated by a single cross over layer pattern situated on the substrate. Each of the layers again uses a feed-out of the electrodes to opposite sides of the substrates. In this manner, the two electrode arrays of each layer can be realised without requiring a crossover within this layer. The two layers of electrodes are mutually arranged so that feed-outs to all four sides of the display are present. Again, if more than one of the column or row electrodes are electrically connected together, the electrical connections must be situated outside of the display area and at the side of the display opposite to that used to drive the at least one of the row-wise electrodes which are not shared with any other rows, and/or at least one of the column-wise electrodes which are not shared with any other columns. However, in this arrangement, the common electrode feed-out may be routed, outside of the display area, to any side of the display, including that where the driver electrode is situated. Again, in this arrangement, pixels can be created with four electrodes per pixel without requiring any cross-over structures within each layer.

The display is completed by providing a second substrate without an electrode pattern. In this arrangement, pixels can again be created with four electrodes per pixel requiring only a single cross-over structures on one substrate. This avoids the need for accurate alignment of the two substrates.

As mentioned above, the provision of four pixel electrodes enables improved pixel designs to be implemented.

FIG. 5 shows one example of use of the four electrodes per pixel, in which the additional fourth electrode is used as a common shielding electrode.

The layout of FIG. 5 is similar to that of FIG. 2A. However, the first array of column electrodes 50 now act as shielding electrodes, and the common reservoir electrode is provided as a series of row electrodes 52. Each pixel thus has a column shielding electrode 50, a column data electrode 54 which connects to the pixel electrodes 26, a row reservoir electrode 52 and a row gate electrode 56. The two row electrode arrays 52,56 could either be present on a second substrate or alternatively as a second metal layer, separated by cross-over structures.

Thus, this arrangement can be provided on two substrates with no cross overs, or on one substrate with a single cross over layer. The additional shielding electrode 50 screens off the electrical fields from one pixel to the neighbouring pixels. This arrangement thus reduces cross talk compared to the arrangement of FIG. 2A. These fields are known to cause cross-talk, by unintentionally moving particles and changing the brightness level of the neighbouring pixel. In FIG. 5, the shielding electrodes 50 are shown connected together as a single electrode. This is not essential, but has the advantage that a single shielding voltage is required for the entire display, which saves on manufacturing costs and complexity. The shielding electrodes are electrically connected at the opposite side of the display to where the column data electrodes will be driven, and the connection area is situated outside of the display area, as required.

In an alternative embodiment, the fourth electrode can be used as an additional data electrode, and an arrangement using this principle is shown in FIG. 6.

The layout of FIG. 6 is similar to that of FIG. 2A. However, the first array of column electrodes 60 now act as additional data electrodes, and the common reservoir electrode is provided as a series of row electrodes 52, as in the example of FIG. 5. Each pixel thus has a column data electrode 60, a column data electrode 54 which connects to the pixel electrodes 26, a row reservoir electrode 52 and a row gate electrode 56.

As for the example of FIG. 5, the two row electrode arrays 52,56 could either be present on a second substrate or alternatively as a second metal layer, separated by cross-over structures. The purpose of the additional data electrodes 60 is to enhance the movement of the particles into the visible pixel area, by introducing a different electrical field distribution whereby the particles either move more quickly from the reservoir to the visible pixel area, or alternatively to realise a more uniform distribution of the particles in the visible pixel area.

In FIG. 6, an independently controllable additional data electrode is provided for each column of pixels. This is not essential, as the additional data electrodes could be connected together. However, it has the advantage that the optimum particle movement can be realised in each of the pixels taking into account the optical state to be realised by the pixel.

The layouts of the invention provide the maximum number of pixel electrodes using a minimum number of crossovers. By utilising contacts and/or electrical connections between columns and or rows to all four sides of the display, it is possible to realise either a 4 electrode pixel design without any crossovers, by situating 2 pixel electrodes on each of the two substrates, or a 4 electrode pixel design with only a single crossover layer, by situating all 4 pixel electrodes on one of the two substrates.

Electrophoretic display systems can form the basis of a variety of applications where information may be displayed, for example in the form of information signs, public transport signs, advertising posters, pricing labels, billboards etc. In addition, they may be used where a changing non-information surface is required, such as wallpaper with a changing pattern or colour, especially if the surface requires a paper like appearance.

The physical design of the pixels has not been described in detail, as this will be known to those skilled in the art.

Various modifications will be apparent to those skilled in the art.

1. A display device, comprising an array of rows and columns of pixels, wherein each pixel comprises portions of first and second row-wise electrodes and portions of first and second column-wise electrodes.

2. A device as claimed in claim 1, wherein each pixel is bounded by the first and second row-wise electrodes, which are not shared with any other rows, and the first and second column-wise electrodes, which are not shared with any other columns.

3. A device as claimed in claim 1, wherein one of first and second row-wise or column-wise electrodes is shared with another row or column, and wherein electrical connection is made outside the display area.

4. A device as claimed in claim 1, wherein the first and second row-wise electrodes are provided on a first substrate, and the first and second column-wise electrodes are provided on a second substrate.

5. A device as claimed in claim 1, wherein the first and second row-wise electrodes and the first and second column-wise electrodes are provided on a common substrate.

6. A device as claimed in claim 5, wherein the first and second row-wise electrodes are provided as a first patterned metal layer and first and second column-wise electrodes are provided as a second patterned metal layer, wherein an insulating layer is located between the metal layers.

7. A device according to claim 1, wherein electrical contacts are made to all four sides of the display.

8. A device as claimed in claim 1, wherein the column-wise electrodes comprise a shielding electrode and a data electrode, and the row-wise electrodes comprise a select electrode.

9. A device as claimed in claim 8, wherein the data electrodes connects to pixel electrode pads.

10. A device as claimed in claim 1, wherein the column-wise electrodes comprise first and second data electrodes and the row-wise electrodes comprise a select electrode.

11. A device as claimed in claim 10, wherein one of the data electrodes connects to pixel electrode pads.

12. A device as claimed in claim 1, comprising an electrophoretic passive matrix display device.

13. A device as claimed in claim 12, wherein each pixel comprises an electrophoretic fluid disposed between opposing substrates.
